(19) United States
(12) Patent Application Publication
(10) Pub. No.: US 2018/0148209 A1
(43) Pub. Date: May 31, 2018

(54) IN-PACKAGE PLASMA SURFACE STERILIZATION SYSTEMS AND METHODS

(71) Applicant: Campbell Soup Company, Camden, NJ (US)

(72) Inventors: Mark Robert Watts, Marlton, NJ (US); Reha Onur Azizoglu, Cherry Hill, NJ (US)

(21) Appl. No.: 15/799,206

(22) Filed: Oct. 31, 2017

Related U.S. Application Data
(60) Provisional application No. 62/417,586, filed on Nov. 4, 2016.

(51) Int. Cl. B65B 55/02; B65B 57/00; A21D 15/04; A23L 3/01; A23L 3/04

(52) U.S. Cl. CPC B65B 55/02; B65B 57/00; B08B 7/0035; A23L 3/01; A23L 3/04; A21D 15/04

(57) ABSTRACT

Embodiments herein include surface sterilization systems and methods for sterilizing packaged food items. In an embodiment, a surface sterilization system is included. The system can have a conveying mechanism configured to move discrete food packages, the food packages having opposed top and bottom surfaces, opposed right and left surfaces, and opposed front and back surfaces. The system can further include a plurality of dielectric discharge electrodes configured to come into sliding contact with the discrete food packages as they are moved by the conveying mechanism. The system can further include an electrical current source in electrical communication with the plurality of dielectric discharge electrodes, the electrical current source delivering a current to the plurality of electrodes sufficient to generate a plasma inside of the discrete food packages. Other embodiments are also included herein.

This application claims the benefit of U.S. Provisional Application No. 62/417,586, filed Nov. 4, 2016, the content of which is herein incorporated by reference in its entirety.

### FIELD

Embodiments herein relate to cold plasma treatment of objects. More specifically, embodiments herein relates to cold plasma treatment of packaged food products.

### BACKGROUND

Bread is one of the most important staple foods in the world. Food products, such as bread, can sometimes begin to spoil after a period of shelf storage. In particular, bread can be spoiled by many different types of molds including Penicillium and Aspergillus species.

Food preservatives can be used to prevent food spoilage. Preservatives are commonly used and have been used for decades. However, many people now seek to avoid foods with preservatives.

### SUMMARY

Embodiments herein include systems and methods for in-package sterilization of surfaces of packaged food items including, for example, surfaces of food items in-package as well as the interior surfaces of the packages themselves. In an embodiment, a surface sterilization system is included. The system can have a conveying mechanism configured to move discrete food packages, the food packages having opposed top and bottom surfaces, opposed right and left surfaces, and opposed front and back surfaces. The system can further include a plurality of dielectric discharge electrodes configured to come into sliding contact with the discrete food packages as they are moved by the conveying mechanism. The system can further include an electrical current source in electrical communication with the plurality of dielectric discharge electrodes, the electrical current source delivering a current to the plurality of electrodes sufficient to generate a plasma inside of the discrete food packages.

In an embodiment, a method of sterilizing packaged food items is included. The method can include feeding packaged food items into a cold plasma treatment station, contacting the packaged food items with dielectric discharge electrodes such that the electrodes slide over the top and side surfaces of the packaged food items and delivering a current to the plurality of dielectric discharge electrodes sufficient to generate a plasma inside of the packaged food items.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following drawings, in which:

FIG. 1 is a schematic view of a cold plasma treatment system in accordance with various embodiments herein.

FIG. 2 is a schematic end view of a cold plasma treatment station in accordance with various embodiments herein.

FIG. 3 is a schematic top view of a cold plasma treatment system in accordance with various embodiments herein.

FIG. 4 is a schematic side view of a cold plasma treatment system in accordance with various embodiments herein.

FIG. 5 is a schematic side view of a cold plasma treatment system in accordance with various embodiments herein.

FIG. 6 is a schematic side view of a cold plasma treatment system in accordance with various embodiments herein.

FIG. 7 is a schematic side view of a cold plasma treatment system in accordance with various embodiments herein.

FIG. 8 is a schematic side view of a cold plasma treatment system in accordance with various embodiments herein.

FIG. 9 is a schematic diagram of a system for generating a plasma within a food package using dielectric barrier discharge.

While embodiments are susceptible to various modifications and alternative forms, specifics thereof have been shown by way of example and drawings, and will be described in detail. It should be understood, however, that the scope herein is not limited to the particular embodiments described. On the contrary, the intention is to cover modifications, equivalents, and alternatives falling within the spirit and scope herein.

### DETAILED DESCRIPTION

The embodiments described herein are not intended to be exhaustive or to limit the invention to the precise forms disclosed in the following detailed description. Rather, the embodiments are chosen and described so that others skilled in the art can appreciate and understand the principles and practices.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

It would be desirable to have a packaged bread product with a reduced amount of preservatives, or no preservatives, while still having a desirable degree of shelf life, but such a product is difficult to achieve.

Plasma is commonly referred to as the fourth state of matter. Plasma is a partially ionized gas with ions, electrons, and uncharged particles such as atoms, molecules, and radicals. There are two types of plasma: thermal and non-thermal or cold atmospheric plasma. Thermal plasma has electrons and heavy particles (neutrals and ions) at the same temperature. Cold Atmospheric Plasma (CAP) is said to be non-thermal because it has electrons at a hotter temperature than the heavy particles that are at room temperature.

Cold plasma treatment systems are disclosed herein that effectively reduce or eliminate yeast and mold vegetative cells and spores that commonly cause bread to spoil. Embodiments of cold plasma treatment systems herein allow for formulations with reduced amounts of preservative or preservative-free formulations, but still allow for bread having the same or greater shelf life as typical breads. Further, the cold plasma sterilization system can treat bread or other foods without substantially affecting the organoleptic properties of the product. The cold plasma treatment system herein can form a plasma within a food package, allowing for sterilization or pasteurization of the surfaces of food items within a food package. This can allow for a desirable degree of shelf life for food products such as bread (but not limited to bread) without the use of preservatives or allowing for reduced use of preservatives.

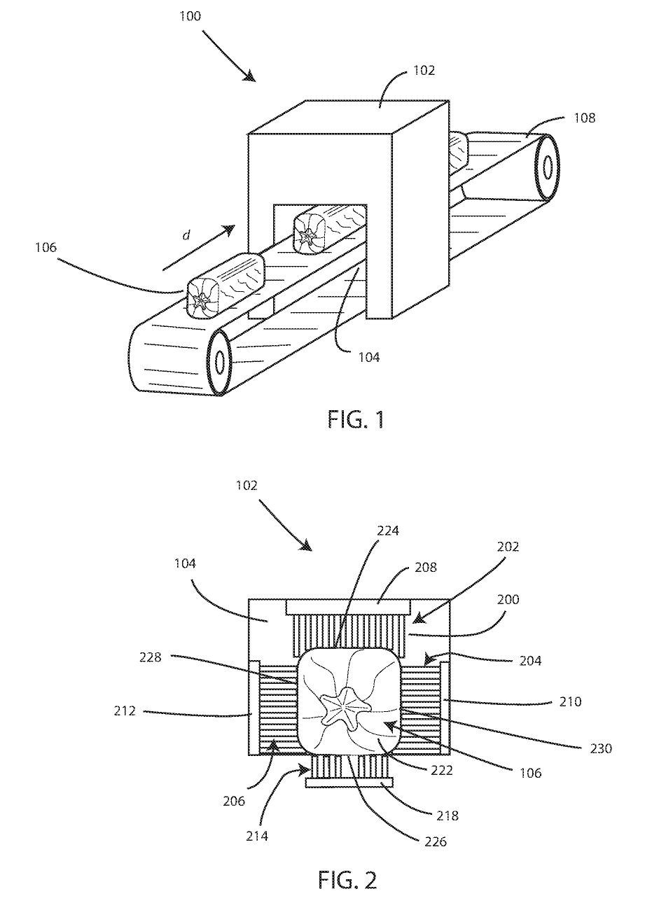

Referring now to FIG. 1, a schematic view is shown of a cold plasma treatment system 100 in accordance with embodiments herein. The cold plasma treatment system 100 is generally used to treat an object with cold plasma. In some embodiments, the cold plasma treatment system 100 is used to sterilize an object by treating it with cold plasma. Generally, an object is introduced to a cold plasma treatment system 100 and moved there through. An object can be moved through the cold plasma treatment system 100 in a conveying direction d. While FIG. 1 shows a single line of objects entering the system, it will be appreciated that in some embodiments multiples lines of objects can be conveyed into a system.

The cold plasma treatment system 100 can include a cold plasma treatment station 102. The cold plasma treatment station 102 is configured to create a cold plasma environment within the packages of the objects, such as food products, that enter. The cold plasma can be generated through dielectric barrier discharge (“DBD”) or other non-thermal plasma generation means, as will be described below herein. The generated cold plasma can be used for treating objects that are passed through the cold plasma treatment system 100. In some embodiments, the generated cold plasma is used to sterilize one or more surfaces of an object that is within a package or one or more wrapper layers.

The cold plasma treatment station 102 can include a treatment tunnel 104. The treatment tunnel 104 is a passage in the cold plasma treatment station 102. A cold plasma environment is created within the packages of objects when they are within the treatment tunnel 104. The treatment tunnel 104 receives an object for treatment. Objects received by and passed through the treatment tunnel 104 are then subjected to conditions sufficient to form a cold plasma within the wrapper or package that the food product is disposed in. For example, the objects can come into contact with dielectric discharge plasma electrodes (or contacts or other system components) that form a cold plasma within a product package such that its surfaces are contacted by cold plasma.

Many different objects can be treated with the cold plasma treatment system 100. In some embodiments, objects treated by the cold plasma treatment system 100 can be packaged loaves of bread 106. Packaged loaves 106 can be discrete food packages, such as food encapsulated by, or disposed within, one or more layers of packaging material such as polymeric or cellulosic wrapper materials. In some embodiments, the packaging material completely seals a food item within the packaging material. In other embodiments, the packaging material may not be completely sealed around the food item.

The cold plasma treatment system 100 can be configured to sterilize the interior surfaces of the packaged loaf 106 (e.g., surfaces of the loaf of bread inside the package). The cold plasma can form radicals and other reactive species that deactivate bacteria, molds, yeasts, and other microbiology. The reactive species can remain inside a packaged loaf 106 for a period after the exposure to plasma is ceased. Further aspects of cold plasma are described in greater detail below.

The cold plasma treatment system 100 can include a conveying mechanism 108. The conveying mechanism generally conveys packaged loaves 106 through the cold plasma treatment station 102. In some embodiments, the conveying mechanism 108 includes a conveyor belt. In some embodiments, the conveying mechanism 108 includes multiple conveyor belts. In some embodiments, the conveying mechanism 108 is integrated with a plasma generating device or electrode.

Although FIG. 1 illustrates a cold plasma treatment system having a single cold plasma treatment station, a cold plasma treatment system can have more than one treatment station. In some cases multiple treatment stations can be positioned in a system such that a packaged loaf is subjected to multiple cold plasma exposures. In some such embodiments, a packaged loaf is subjected to cold plasma exposures in succession such that a packaged loaf has an increased, continuous exposure time to reactive species generated by cold plasma exposure.

Referring now to FIG. 2, a schematic view is shown of a cold plasma treatment station 102 in accordance with various embodiments herein. The treatment station 102 generally has a facility for generating a cold plasma. The cold plasma is generated within packaged objects within in a treatment tunnel 104. The treatment station 102 can include a plurality electrodes 200 configured to generate conditions sufficient to create a plasma.

The electrodes can take on many different specific configurations. In some embodiments, the electrodes 200 can be configured similar to bristles that brush against a packaged loaf 106 as it is passed through the treatment tunnel 104. In some embodiments, the electrodes can be elongated ribbon-like structures having substantial flat surfaces configured to brush against packages loaves. However, in other embodiments, the electrodes can be more circular in cross-section. In some embodiments, the electrodes can have a substantially similar shape along the entire length of the electrodes. However, in other embodiments, the electrodes can have differently shaped portions, such as a relatively flattened portion near the end and another portion, away from the end, that is less flattened. In addition, the width of the electrode can be the same along the entire length of the electrodes or can vary. In some embodiments, the electrode can have a wider portion near its distal end.

In some embodiments, the electrodes 200 cause a cold plasma to be formed in response to being energized with electric current. Mechanisms of plasma generation are discussed in greater detail below. However, in many cases, the electrodes 200 create an electric field that generates a cold plasma. The electrodes can specifically cause the generation of a cold plasma within the packaging of a packaged food item, such as a packaged loaf 106. The electrodes 200 can each be configured to generate a plasma that contacts a certain area of an inside surface of a packaged loaf that is contacted by the electrodes 200. The electrodes can be spaced such that the plasma generated by adjacent electrodes overlaps such that the entire width, height, or other dimension of an inside surface of a packaged loaf is contacted by a continuous region of cold plasma. Further aspects of electrode construction are described in greater detail below.

The treatment tunnel 104 can include a plurality of top electrodes 202. The top electrodes 202 can be mounted to a top electrode manifold 208. The treatment tunnel 104 can include a plurality of right side electrodes 204. The right side electrodes 204 can be mounted to a right side electrode manifold 210. The treatment tunnel 104 can include a plurality of left side electrodes 206. The left side 206 electrodes can be mounted to a left side electrode manifold 212. The treatment tunnel 104 can include a plurality of bottom electrodes 214. The bottom electrodes 214 can be mounted to a bottom electrode manifold 218. In some embodiments, the bottom electrodes 214 are distributed on more than one bottom electrode manifold 218. In some embodiments, bottom electrodes are incorporated with a conveying mechanism. However, it will be appreciated that in various embodiments, manifold structures are omitted.

The cold plasma treatment tunnel 104 can be used to treat a packaged loaf 106. The packaged loaf 106 can have a front surface (not shown in this view), a back surface 222, a top surface 224, a bottom surface 226, a left surface 228 and a right surface 230. The front surface can be opposite the back surface 222. The bottom surface 226 can be opposite the top surface 224. The left surface 228 can be opposed to the right surface 230. As used herein, surfaces that are “opposed” are surfaces that are opposite one another.

The packaged loaf 106 can be conveyed through the electrodes 200. The electrodes 200 can be configured to come into contact with the packaged loaf 106. The electrodes 200 can be configured to make sliding contact with a packaged loaf that is conveyed there through. In some embodiments, the top electrodes 202 are configured to come into sliding contact with the top surface 224 of the packaged loaf 106. In some embodiments, the right side electrodes 204 are configured to come into sliding contact with the right surface 230 of the packaged loaf 106. In some embodiments, the left side electrodes 206 are configured to come into sliding contact with the left surface 228 of the packaged loaf 106. In some embodiments, the bottom electrodes 216 are configured to come into sliding contact with the bottom surface 226 of the packaged loaf 106. In some embodiments, one or more of the top electrodes 202, the right side electrodes 204, the left side electrodes 206, and the bottom electrodes 214 are configured to come into sliding contact with the front surface of the packaged loaf 106. In some embodiments, one or more of the top electrodes 202, the right side electrodes 204, the left side electrodes 206, and the bottom electrodes 214 are configured to come into sliding contact with the back surface 222 of the packaged loaf 106.

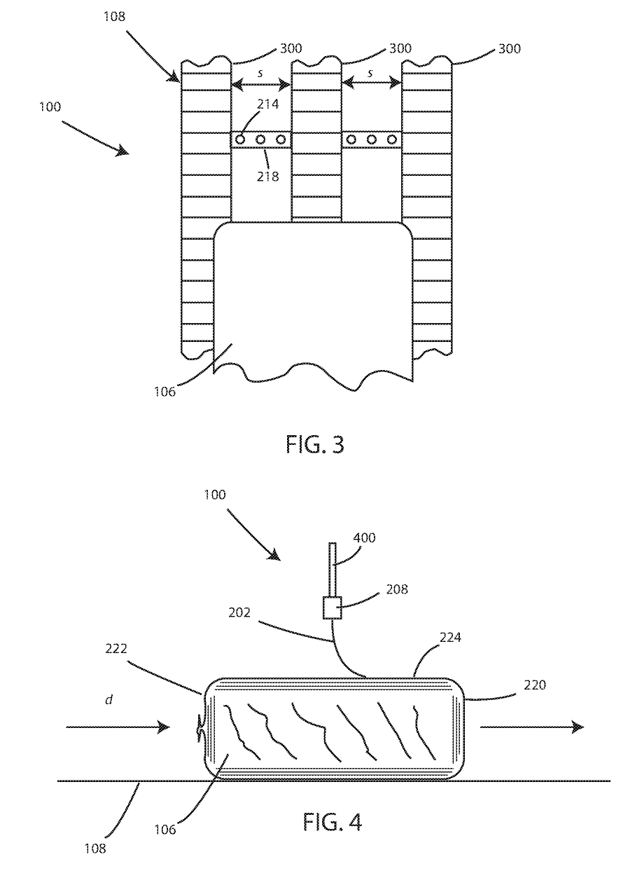

Referring now to FIG. 3, a schematic top view is shown of a cold plasma treatment system 100 in accordance with various embodiments herein. A conveying mechanism 108 can allow a bottom surface of a packaged loaf 106 to be treated with cold plasma while being conveyed through the cold plasma treatment system 100. In this example, the conveying mechanism 108 can be configured as a split-belt conveyor. The conveying mechanism 108 can include a plurality of conveyors 300. FIG. 3 specifically illustrates a conveying mechanism 108 having three conveyors 300. However, a different number of conveyors can also be used.

The conveyors 300 can be spaced a distance away from each other by spaces s. In some embodiments, electrodes 214 can fit within the spaces s between adjacent conveyors 300. In such embodiments, the bottom surface of a packaged loaf 106 can slidingly contact the electrodes 214 and thereby be exposed to a cold plasma environment as it is conveyed through the system. For example, the plurality of conveyors 300 can be configured to move in synchrony to convey a packaged loaf 106 in a conveying direction 110 over one or more bottom electrodes 214 disposed in the spaces s. The bottom electrodes 214 can cause a cold plasma to be generated when a packaged loaf 106 is conveyed there over. Other conveying mechanism configurations are also contemplated that allow a bottom surface of a packaged loaf or other object to be treated with cold plasma while being conveyed.

Various electrode configurations are disclosed herein. Generally, the electrodes 200 can produce a cold plasma inside a packaged loaf or other object that contacts the electrodes. In some embodiments, the electrodes contact the object being treated by the system. In some embodiments, the electrodes are in sliding contact with an object being treated by the system. In some embodiments, at least a portion of each electrode is able to be moved or displaced, such that the electrode can maintain contact with an object having varying dimensions as the object is conveyed through the electrodes. Various electrode configurations that allow sliding contact between electrode and packaged loaf will be described herein with reference to the figures.

Referring now to FIG. 4, a schematic side view is shown of a cold plasma treatment system 100 in accordance with various embodiments herein. FIG. 4 shows a conveying mechanism 108 moving a packaged loaf 106 in a conveying direction d past a plurality of top electrodes 202. The top electrodes 202 are in sliding contact with the top surface 224 of the packaged loaf 106. The possible side and bottom electrodes are not shown in this view for ease of illustration.

The top electrodes 202 are held by a top electrode manifold 208, however in some embodiments a manifold structure can be omitted and the electrodes can be mounted to a frame or similar structure. In some embodiments, the top electrode manifold 208 is rigidly connected to a top support structure 400. However, in other embodiments the top electrode manifold 208 is not rigidly connected to the top support structure 400.

In some embodiments, the top electrodes 202 are flexible, and deflect as the packaged loaf 106 is passed there through. In some cases, the top electrodes can be mounted to be spring-loaded. In some embodiments, the top electrodes 202 are resiliently biased towards the packaged loaf 106 such that the top electrodes 202 can follow the contours of packaged loaves 106 passed through the top electrodes. In some embodiments, the top electrodes 202 contact the front surface of a packaged loaf 106 as it is initially conveyed into the top electrodes 202. As the packaged loaf 106 is further moved along in the conveying direction d, the top electrodes can flex or deflect such that the electrodes can maintain sliding contact with the packaged loaf 106 despite possible variation in surface height. As the packaged loaf 106 is further moved along in the conveying direction d, the top electrodes can relax as the electrodes follow the shape of the packaged loaf 106 and contact its back surface 222.

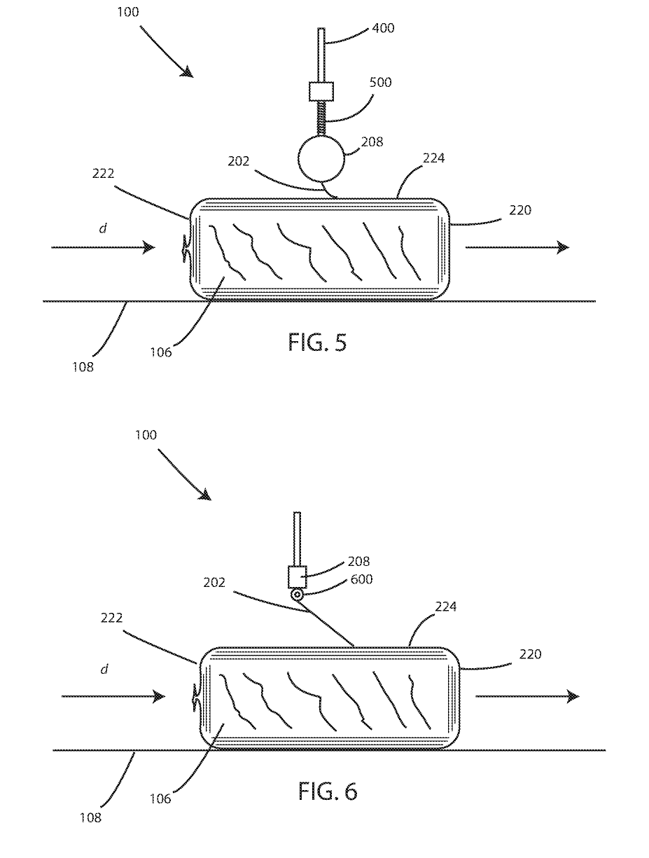

Referring now to FIG. 5, a schematic side view is shown of a cold plasma treatment system 100 in accordance with various embodiments herein. FIG. 5 shows a conveying mechanism 108 moving a packaged loaf 106 in a conveying direction d past a plurality of top electrodes 202. The top electrodes 202 are in sliding contact with the top surface 224 of the packaged loaf 106.

The top electrodes 202 are held by a top electrode manifold 208. The top electrode manifold 208 is movably connected to a top support structure 400 by a manifold movement structure 500. The manifold movement structure 500 allows relative motion between the top electrode manifold 208 and a top support structure 400. The manifold movement structure 500 allows the top electrode manifold 208 and the attached top electrodes 202 to be displaced (actively or passively) to accommodate varying dimensions of a packaged loaf 106. In some embodiments, the top electrodes 202 can contact the front surface of a packaged loaf 106 as it is initially conveyed into the top electrodes 202. As the packaged loaf 106 is further moved along in the conveying direction d, the top electrode manifold 208 is displaced upward such that the electrodes can maintain sliding contact with the packaged loaf 106 and brush against its top surface 224. As the packaged loaf 106 is further moved along in the conveying direction d, the top electrode manifold 208 is displaced downward as the electrodes follow the shape of the packaged loaf 106 and slide along in contact with its back surface 222.

In some embodiments, the manifold movement structure 500 allows the top electrode manifold 208 and the attached top electrodes 202 to be vertically displaced. In such embodiments, the manifold movement structure 500 can be a vertical movement structure. Likewise, right or left side electrodes may incorporate a similar horizontal movement structure. In some embodiments, the manifold movement structure 500 allows the top electrode manifold 208 and the attached top electrodes 202 to be linearly displaced. In some embodiments, the manifold movement structure 500 allows the top electrode manifold 208 and the attached top electrodes 202 to be angularly displaced. In such embodiments, the manifold movement structure can include a hinge or other angular bearing structure. In some embodiments, the manifold movement structure 500 is biased downwards toward the packaged loaf 106. In such embodiments, the top electrodes 202 are urged toward the packaged loaf 106 such that they can maintain sliding contact with the top surface 224 of the packaged loaf 106 as it is passed through the top electrodes 202. In some embodiments, the top electrodes 202 are flexible, as described above with reference to FIG. 4. In other embodiments, the top electrodes 202 are substantially rigid.

The top electrode manifold 208 can be cylindrical. In some embodiments, the top electrode manifold 208 is a roller. A roller manifold can include electrode banks positioned about the circumference of the manifold, the electrodes being spokes about the hub-like manifold. In such embodiments, the roller manifold can be rotated such that the electrode banks brush against a surface to be treated. However, in other embodiments, the top electrode manifold is cylindrical, but does not roll and can serve a function like a bumper. In some embodiments, contact of the packaged loaf 106 with the top electrode manifold can trigger a sensor and can cause the manifold movement structure to activate and move the manifold vertically.

Referring now to FIG. 6, a schematic side view is shown of a cold plasma treatment system 100 in accordance with various embodiments herein. FIG. 6 shows a conveying mechanism 108 moving a packaged loaf 106 in a conveying direction d past a plurality of top electrodes 202. The top electrodes 202 are in sliding contact with the top surface 224 of the packaged loaf 106.

The top electrodes 202 are each movably coupled to a top electrode manifold 208 by an electrode movement structure 600, in this case similar to a hinge joint. The electrode movement structures 600 allow each top electrode 202 to be independently moved relative to the top electrode manifold 208. The top electrodes 202 are displaced as the packaged loaf 106 is passed through. In some embodiments, the top electrodes 202 are resiliently biased towards the packaged loaf 106 such that the top electrodes 202 can follow contours of packaged loaves 106 that are passed through the top electrodes.

In some embodiments, the top electrodes 202 can contact the front surface of a packaged loaf 106 as it is initially conveyed into the top electrodes 202. As the packaged loaf 106 is further moved along in the conveying direction d, the top electrodes are displaced such that the electrodes can maintain sliding contact with the packaged loaf 106 and brush against its top surface 224. As the packaged loaf 106 is further moved along in the conveying direction d, the top electrodes can be displaced as the electrodes the shape of the packaged loaf 106 and slide along in contact with its back surface 222.

In some embodiments, the electrode movement structure 600 allows the top electrodes 202 to be vertically displaced. In some embodiments, the electrode movement structure 600 allows the top electrodes 202 to be angularly displaced. In some embodiments, the top electrodes 202 are flexible, as described above with reference to FIG. 4. In other embodiments, the top electrodes 202 are substantially rigid.

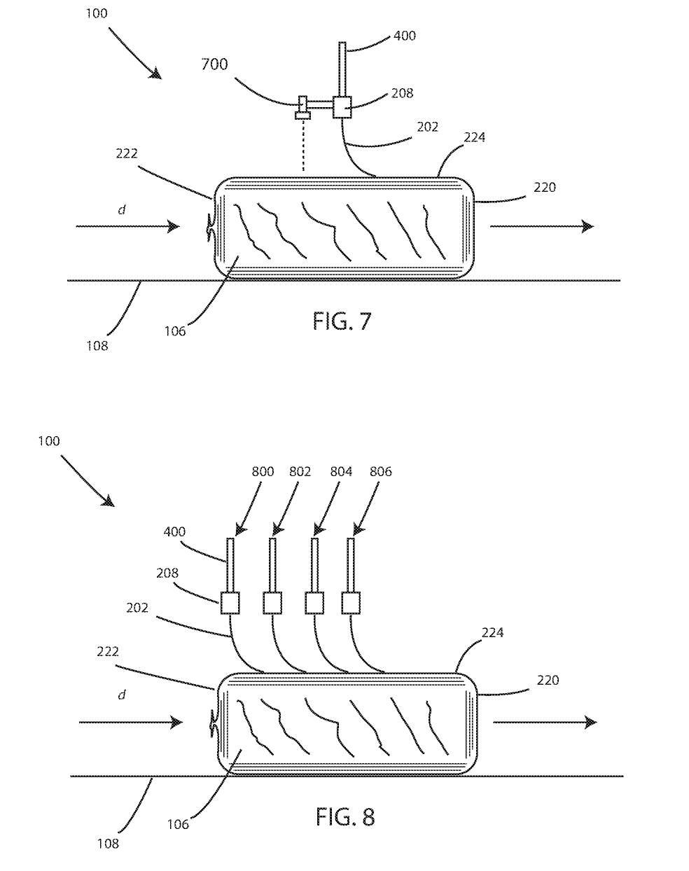

Referring now to FIG. 7, a schematic side view is shown of a cold plasma treatment system 100 in accordance with various embodiments herein. FIG. 7 shows a conveying mechanism 108 moving a packaged loaf 106 in a conveying direction d past a plurality of top electrodes 202. The top electrodes 202 are in sliding contact with the top surface 224 of the packaged loaf 106.

The cold plasma treatment system 100 can include a proximity sensor 700. The proximity sensor can detect the presence of a packaged loaf 106. In some embodiments, the proximity sensor can determine the position of a packaged loaf 106 with reference to a portion of the cold plasma treatment system 100. The proximity sensor can also determine the topography or other shape of a packaged loaf 106. The information obtained by the proximity sensor 700 can be used to control various aspects of the cold plasma treatment system 100. Information from the proximity sensor 700 can be used to control the timing of plasma generation. Information from the proximity sensor 700 can be used to control the position of one or more movable electrodes or electrode manifolds. Information from the proximity sensor can be used to control the speed of a conveying mechanism 108. Information from the proximity sensor can be used to control the position of a conveying system. Information from the proximity sensor can be used to turn electrodes off or on.

The cold plasma treatment system 100 can selectively generate plasma when a packaged loaf 106 is at a certain, defined position. The cold plasma treatment system 100 can selectively cease plasma generation when a packaged loaf 106 is at a certain, defined position. In some embodiments, the cold plasma treatment system 100 begins generating plasma when the front surface of a packaged loaf 106 is a certain distance from the top electrodes 202. In some embodiments, the cold plasma treatment system 100 ceases plasma generation when the back surface 222 of a packaged loaf 106 is a certain distance from the top electrodes 202.

The cold plasma treatment system can selectively displace one or more electrodes when a packaged loaf 106 is at a certain, defined position. The cold plasma treatment system 100 can include one or more movable electrode manifolds that can be selectively moved in response to input from the proximity sensor. For example, the proximity sensor may detect the presence of an incoming packaged loaf, and a movable manifold may be lowered into an initial position to cause one or more plasma-generating electrodes to engage a desired portion of the packaged loaf. Similarly, the cold plasma treatment system 100 can include one or more movable electrodes that be selectively moved in response to input from the proximity sensor. For example, the proximity sensor can determine the topography of a packaged loaf and selectively position one or more individual electrodes such that they follow the contours of the packaged loaf.

A proximity sensor can be any input device that can determine the position, presence, or shape of an object. A proximity sensor can be of the infrared, sonic, ultrasonic, capacitive, photoelectric, and other electromagnetic type. A proximity sensor can include a camera, photocell, light beam detector, and other means of determining the presence or position of an object without physical contact. A proximity sensor can also include physical contact detection equipment, such as switches, pressure transducers, strain gauges, and the like.

Referring now to FIG. 8, a schematic side view is shown of a cold plasma treatment system 100 in accordance with various embodiments herein. FIG. 4 shows a conveying mechanism 108 moving a packaged loaf 106 in a conveying direction d past a plurality of top electrodes 202. The top electrodes 202 are in sliding contact with the top surface 224 of the packaged loaf 106.

FIG. 8 illustrates a cold plasma treatment system 100 having a first electrode bank 800, a second electrode bank 802, a third electrode bank 804, and a fourth electrode bank 806. Each electrode bank is configured to treat a packaged loaf 106 with a cold plasma. Systems having more than one electrode bank can increase the time that a packaged loaf 106 is exposed to cold plasma. Systems having more than one electrode bank can decrease the throughput time of a particular packaged loaf 106 while maintaining a given cold plasma exposure time. The number of electrode banks is not particularly limited, and can be tailored to a particular exposure time or throughput need. Similarly, the spacing of electrode banks is not particularly limited.

Each of the electrode banks can include a plurality of top electrodes 202, a top electrode manifold 208, and a support structure 400. Although the particular electrode banks illustrated in FIG. 8 each have a configuration similar to the electrodes of FIG. 4, other configurations are possible. Any of the electrode configurations disclosed herein can be incorporated on a system having more than one electrode bank.

Although FIGS. 4-8 illustrate particular electrode configurations with reference to the top electrodes 202, it is to be understood that other electrodes disclosed herein may have such configurations. For example, left or right side electrodes or bottom electrodes may have a similar configuration to any of those described with reference to the top electrodes. Further, while FIGS. 1-8 illustrate particular cold plasma treatment systems and methods with respect to a packaged loaf, other objects can be treated by the systems and methods disclosed herein.

### Objects Treated

Many objects can be subjected to a cold plasma treatment. Generally, an object is moved through a region of cold plasma to be treated. An object to be treated is generally a discrete unit having one or more surfaces to be treated by the cold plasma system. In some embodiments, an object to be treated is a packaged item. In some embodiments, an object to be treated is a discrete food package. In some embodiments, an object to be treated is encapsulated by a polymeric or cellulosic package or packages. In such embodiments, the packaging material can be made of a polyolefin, polyester, polyvinyl chloride, polyethylene, and other polymeric materials. In some embodiments, the packaging material can be a kraft paper, waxed paper, lined paper, or other type of cellulosic material. In some embodiments, an object to be treated is a loaf of bread packaged in a polymeric or cellulosic wrapper. In some embodiments, the object to be treated has an inner polymeric or cellulosic wrapper and an outer polymeric or cellulosic wrapper. However, in various embodiments the object to be treated is only within a single polymeric or cellulosic wrapper.

The discrete object to be treated can have more than one surface to be treated. In some embodiments, the discrete item is substantially prismatic (e.g., a solid object with two identical ends and flat sides). In some embodiments, the discrete object is substantially a rectangular prism. In some embodiments, the discrete object has opposed top and bottom surfaces. In some embodiments, the discrete object has opposed right and left surfaces. In some embodiments, the discrete object has opposed front and back surfaces. In some embodiments, the discrete object has a height and a width. In some embodiments, the discrete object has a height and a width, the height being at least 0.5 times the width. In some embodiments, the discrete object has a height and a width, the height being at least 0.75 times the width.

In some embodiments, the object to be treated is a packaged loaf. The packaged loaf can be a packaged loaf of bread. A loaf of bread can be encapsulated by a polymeric or cellulosic wrapper. A loaf of bread to be treated can be encapsulated by an inner polymeric or cellulosic wrapper and an outer polymeric or cellulosic wrapper. In some embodiments, the object to be treated is a flatbread, such as naan, pita, and the like. In some embodiments, the object to be treated comprises a bulk amount of another food item.

### Methods

Treating an object with cold plasma includes contacting at least some of the surfaces of an object disposed within a package with a cold plasma for an exposure time. In some embodiments, the surface of an object is sterilized by a cold plasma treatment. In such embodiments, sterilization deactivates at least some microorganisms or other biological agents present on the surface of the object. In some embodiments, the surface chemistry of an object is modified or changed as a result of cold plasma treatment.

An object to be treated can be conveyed through a cold plasma treatment system. An object is generally conveyed through a cold plasma treatment system by a conveying mechanism. A conveying mechanism can be configured to receive objects and carry them through a treatment system. A conveying mechanism of a cold plasma treatment system can be integrated with or in communication with one or more other conveying mechanisms included in an object's processing environment. A conveying mechanism can include one or more conveyor belts. A conveying mechanism can include one or more chains with object-engaging elements. A conveying mechanism can include any mechanism for providing an object to be treated with the facility to be moved through a cold plasma treatment system.

Objects to be treated can be fed into a cold plasma treatment station. In some embodiments, a conveying mechanism feeds objects to be treated into a cold plasma treatment station. In some embodiments, a conveying mechanism moves objects to be treated through a cold plasma treatment station. The cold plasma treatment station can be a region in a cold plasma treatment system or in an overall food production or processing system wherein an object undergoes cold plasma treatment. The cold plasma treatment station can be consistent with those described herein. In some embodiments, the cold plasma treatment station includes a treatment tunnel through which an object to be treated is moved. The cold plasma treatment station can include one or more electrodes that produce cold plasma.

An object to be treated can be contacted by one or more electrodes of a cold plasma treatment station. An object to be treated can be contacted by one or more electrodes such that the one or more electrodes slide over the one or more surfaces of the object. Electrodes can contact any combination of one or more of the top surface, the side surfaces, the front surface, the back surface, the bottom surface, or any other surface of an object to be treated. Electrodes can slide over any combination of one or more of the top surface, the side surfaces, the front surface, the back surface, the bottom surface, or any other surface of an object to be treated. In some embodiments, the conveying mechanism includes one or more electrodes. The electrodes of a cold plasma treatment station can be consistent with the electrode configurations disclosed herein with reference to the figures.

Electric current is provided to the electrodes by a current source. The current provided to the electrodes is such that they generate a cold plasma. The current provided to the electrodes is sufficient to generate a cold plasma in contact with the object to be treated. In some embodiments, the current delivered to a plurality of electrodes is sufficient to generate a plasma inside of a packaged object. In some embodiments, the current delivered to the plurality of electrodes is sufficient to generate a plasma inside of a discrete food package. In such embodiments, a cold plasma is generated between an object and its packaging material, thereby contacting the object.

In some embodiments, the plurality of electrodes are energized while a discrete object is conveyed there through. In some embodiments, current is provided to the plurality electrodes when at least some of a plurality of electrodes initially meets a discrete object. In some embodiments, current is provided to the plurality electrodes when a discrete object at a certain position in the treatment system. In some embodiments, the current provided to the plurality of electrodes is ceased when at least some of the plurality of electrodes are no longer in contact with a discrete object. In some embodiments, the current provided to the plurality of electrodes is ceased when a discrete object is at a certain position in the treatment system.

Discrete objects can be conveyed through the cold plasma treatment system in a substantially continuous manner. However, in some embodiments, discrete objects are conveyed through a plurality of electrodes intermittently.

The systems disclosed herein are generally configured to generate a cold plasma that contacts a surface to be treated. In some embodiments, the system is configured to generate a cold plasma inside of a package. In the context of food sterilization, a cold plasma can be generated inside of a packaged food such that the food can be sterilized in situ. A plasma formed within a package exposes the food or other contents therein to the reactive species formed by the cold plasma. The reactive species act to deactivate microorganisms and spores present on the surface of a food.

### Process Parameters

Packaged loaves, discrete food items, and other objects treated by a cold plasma treatment system are generally in direct contact with a cold plasma for a given exposure time. The exposure time is dependent on the speed at which objects are conveyed through the plurality of electrodes, and the size of the cold plasma environment created by the plurality of electrodes. The exposure time can be selected to sufficiently sterilize, modify, or otherwise treat an object.

In some embodiments, the exposure time is about 0.1 seconds to 90 seconds. In some embodiments, the exposure time is about 1 second to 60 seconds. In some embodiments, the exposure time is about 0.1 seconds to 60 seconds. In some embodiments, the exposure time is about 0.1 seconds to 20 seconds. In some embodiments, the exposure time is about 2 seconds to 20 seconds. In some embodiments, the exposure time is about 0.1 seconds to 15 seconds. In some embodiments, the exposure time is about 0.1 seconds to 10 seconds. In some embodiments, the exposure time is less than about 10 seconds. In some embodiments, the exposure time is about 0.1 seconds to 5 seconds. In some embodiments, the exposure time is about 0.1 seconds to 2.5 seconds. In some embodiments, the exposure time is about 0.1 seconds to 1 second. In some embodiments, the exposure time is about 0.1 seconds to 0.5 seconds. In some embodiments, the exposure time is about 1 second to 4 seconds. In some embodiments, the exposure time is about 0.5 seconds to 15 seconds.

The cold plasma treatment system is configured to treat a certain amount of packaged food items or other objects per unit of time. In some embodiments, the throughput of a cold plasma treatment system matches the throughput of an existing line process of an object to be treated. In some embodiments, the throughput speed of the cold plasma treatment system is adjustable to accommodate different exposure times or different objects.

In some embodiments, the throughput speed is about 0.1 packages per minute to 1000 packages per minute. In some embodiments, the throughput speed is about 1 packages per minute to 500 packages per minute. In some embodiments, the throughput speed is about 10 packages per minute to 250 packages per minute. In some embodiments, the throughput speed is about 20 packages per minute to 250 packages per minute. In some embodiments, the throughput speed is about 20 packages per minute to 200 packages per minute. In some embodiments, the throughput speed is about 20 packages per minute to 150 packages per minute. In some embodiments, the throughput speed is about 50 packages per minute to 100 packages per minute. In some embodiments, the throughput speed is about 50 packages per minute to 100 packages per minute. In some embodiments, the throughput speed is about 1 package per minute to 100 packages per minute.

### Plasma Generation Techniques

The “cold plasma” referred to herein can mean any nonthermal plasma. Cold plasma can have a temperature near to the temperature of an ambient environment. For example, cold plasma can have a temperature close to room temperature. Cold plasma can have a temperature less than about 100 degrees Celsius. Cold plasma can occur at a pressure nearing atmospheric pressure. Cold plasma can be composed of positive ions, negative ions, electrons, neutral atoms or molecules, excited atoms or molecules, radicals, and ultraviolet photons. Cold plasma can have a net electric charge of zero. US Patent Application Publication 2016/0193373 describes various aspects of cold plasma, and is herein incorporated by reference. Cold plasma occurring in air can be characterized by the presence of one or more reactive species. In some embodiments, cold plasma is characterized by a high concentration of reactive species. Reactive species can include reactive oxygen species and reactive nitrogen species. Specifically, reactive species can include ozone, hydroxide radicals, nitrogen oxides, and the like.

Various techniques are known for generating cold plasma. The “electrodes” described herein generally facilitate the production of cold plasma by way of dielectric barrier discharge (“DBD”), however other techniques can also be used. For dielectric barrier discharge, typically there are at least two electrodes (a high voltage electrode and a ground electrode) and a dielectric barrier between the two electrodes. In some cases the dielectric barrier covers at least one of the electrodes. In some cases, both electrodes are covered by dielectric barriers. The supplied electrical energy creates an electrical discharge between the two electrodes.

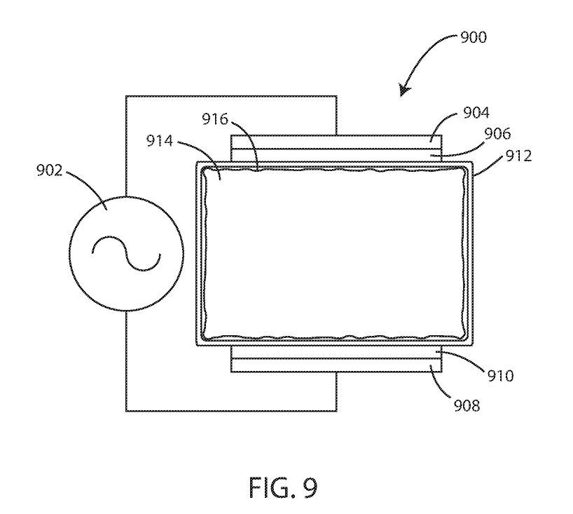

Referring now to FIG. 9, a schematic diagram is shown of a system 900 for generating a plasma within a food package using dielectric barrier discharge. The system 900 can include a current source or generator 902. The current source 902 can be connected to a high voltage electrode 904 and a ground electrode 908. A dielectric layer 906 can cover the high voltage electrode 904 and a dielectric layer 910 can cover the ground electrode 908. Optionally, one or both of the dielectric layers can be omitted in some scenarios. In between the electrodes is a food package 912 including a food product 914 therein, such as a loaf of bread. There can be a small amount of space 916 between the food product 914 and the food package 912 and a cold plasma can be generated in this space.

Current is provided to the electrodes at a sufficient voltage and frequency such that they generate cold plasma within food packages. The nature of the supplied current depends on the plasma generating technique employed. In many cases the supplied current is an alternating electric current (“AC”). AC current can have various waveforms such as sinusoidal waveform, a square waveform, a triangular waveform, a sawtooth waveform, a rectangular waveform, and the like. However, in some cases the current can be direct electric current (“DC”), such as if a semiconductor layer of gallium arsenide is used to replace the dielectric layer.

Current can be supplied at various frequencies. The frequency can be from about 0 Hz to 100 Hz. The frequency can be from about 1 Hz to 1 kHz. The frequency can be from about 1 kHz to 1 MHz. The frequency can be from about 1 MHz to 100 MHz. The frequency can be from about 100 MHz to 1 GHz. The frequency can be from about 1 GHz to 100 GHz. The frequency can be greater than about 100 GHz.

Current can be supplied at a voltage. The voltage can be from about 0 V to 10 V. The voltage can be from about 10 V to 100 V. The voltage can be from about 100 V to 1 kV. The voltage can be from about 1 kV to 5 kV. The voltage can be from about 5 kV to 10 kV. The voltage can be from about 10 V to 20 kV. The voltage can be from about 20 kV to 100 kV. The voltage can be greater than about 100 kV. In some embodiments, the voltage is from about 10 kV to 50 kV. In some embodiments, the voltage is from about 25 kV to 40 kV. The above voltages can refer to peak current amplitudes, DC voltages, RMS voltages, and other measures of electric potential of an electric current.

### Electrode Design and Materials

An electrode can be configured to create the electrical field necessary for the formation of a cold plasma. As described herein, an electrode can create plasma by way of any known technique for generating cold plasma. The electrodes can be configured to maximize the amount of cold plasma generated inside a package while minimizing the amount of cold plasma generated outside a package.

An electrode can include various electrical and structural components that facilitate the generation and emission of plasma. An electrode can be configured to generate plasma in response to receiving an electric current. An electrode can have a region where an electric discharge occurs. An electrode can have a region where an electric field is formed. An electrode can have an anode and cathode. An electrode can include one or more integrated circuits. An electrode can include one or more printed circuits. An electrode can have a facility for modifying an electrical signal.

The electrodes can be constructed at least partially of an electrically conductive material. Suitable electrically conductive materials include copper, aluminum, steel, other metals, graphite, conductive polymers, and the like. The electrodes can be constructed at least partially of a dielectric material. Suitable dielectric materials include porcelain, glass, parylene, other polymers, and the like. Gaseous dielectric substances can be used for the operation of an electrode. Suitable gaseous dielectric substances include air, nitrogen, sulfur hexafluoride, and the like. The electrodes can be constructed at least partially of an electrically insulating material. Suitable electrical insulators include glass, paper, porcelain, other ceramics, clay, quartz, alumina, feldspar, other minerals, rubber, polyvinyl chloride, polycarbonate, acrylonitrile butadiene styrene, other plastics, and other polymers.

Various configurations of electrode banks can be used in systems consistent with those disclosed herein. Various electrode configurations where shown with reference to the attached figures incorporating single-bank arrays of electrodes used to treat packaged foods or other objects. It is to be understood that a cold plasma treatment system could incorporate any number of electrode banks. For example, an object may pass through multiple treatment zones defined by the presence of electrodes as it is conveyed through a treatment system. The surfaces of a packaged food item can undergo multiple plasma treatments in order to sufficiently treat the object.

In some embodiments, a cold plasma treatment station includes 1 electrode bank. In some embodiments, a cold plasma treatment station includes more than 1 electrode bank. In some embodiments, a cold plasma treatment station includes 2 electrode banks. In some embodiments, a cold plasma treatment station includes 3-10 electrode banks. In some embodiments, a cold plasma treatment station includes 10-100 electrode banks.

In some embodiments, a cold plasma treatment system includes more than one treatment station. In some embodiments, a cold plasma treatment system includes 2 cold plasma treatment stations. In some embodiments, a cold plasma treatment system includes 3 cold plasma treatment stations. In some embodiments, a cold plasma treatment system includes more than 3 cold plasma treatment stations.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

Aspects have been described with reference to various specific and preferred embodiments and techniques. However, it should be understood that many variations and modifications may be made while remaining within the spirit and scope herein.

1. A surface sterilization system comprising:
a conveying mechanism configured to move discrete food packages, the food packages having opposed top and bottom surfaces, opposed right and left surfaces, and opposed front and back surfaces;
a plurality of dielectric discharge electrodes configured to come into sliding contact with the discrete food packages as they are moved by the conveying mechanism; and
an electrical current source in electrical communication with the plurality of dielectric discharge electrodes, the electrical current source delivering a current to the plurality of electrodes sufficient to generate a plasma inside of the discrete food packages.

2. The sterilization system of claim 1, the plurality of dielectric discharge electrodes comprising flexible electrodes that bend upon contact with the discrete food packages.

3. The sterilization system of claim 1, the plurality of dielectric discharge electrodes connected to a joint allowing the electrodes to deflect upon contact with the discrete food packages.

4. The sterilization system of claim 1, the plurality of dielectric discharge electrodes comprising a first set of electrodes configured to contact the top surface of the food package, a second set of electrodes configured to contact the right surface of the food package, and a third set of electrodes configured to contact the left surface of the food package.

5. The sterilization system of claim 1, wherein at least some of the plurality of dielectric discharge electrodes are configured to contact the front surface of the food package as the food package initially meets the electrodes.

6. The sterilization system of claim 1, wherein at least some of the plurality of dielectric discharge electrodes are configured to contact the back surface of the food package as the food package passes the electrodes.

7. The sterilization system of claim 1, the conveying mechanism comprising a first conveying surface and a second conveying surface, and a gap between the first conveying surface and the second conveying surface oriented along the lengthwise axis of the conveying mechanism, the system further including one or more dielectric discharge electrodes disposed within the gap.

8. (canceled)

9. The sterilization system of claim 1, comprising a proximity sensor to detect the presence of a food package at a defined point with respect to the plurality of dielectric discharge electrodes.

10. The sterilization system of claim 9, wherein plasma generation is switched on or off based on a signal from the proximity sensor.

11. The sterilization system of claim 1, comprising a proximity sensor to detect the distance to a food package at a defined point with respect to the plurality of dielectric discharge electrodes.

12. The sterilization system of claim 1, wherein the plasma is generated via dielectric barrier discharge.

13. The sterilization system of claim 1, the electrical current source providing a current at a voltage of 20-40 kV and a frequency of 1-10 kHz.

14. (canceled)

15. The sterilization system of claim 1, the food packages comprising a sealed polymeric wrapper.

16. The sterilization system of claim 1, the food packages comprising a loaf of bread disposed within a polymeric or cellulosic wrapper.

17-19. (canceled)

20. The sterilization system of claim 1, further comprising a cylinder-shaped member, wherein at least some of the plurality of electrodes are attached to the cylinder-shaped member.

21-22. (canceled)

23. A method of sterilizing packaged food items, the method comprising:
feeding packaged food items into a cold plasma treatment station;
contacting the packaged food items with dielectric discharge electrodes such that the electrodes slide over the top and side surfaces of the packaged food items; and
delivering a current to the plurality of dielectric discharge electrodes sufficient to generate a plasma inside of the packaged food items.

24. The method of claim 23, the dielectric discharge electrodes maintaining contact with the food items for about 0.5 seconds to about 30 seconds.

25. The method of claim 23, the dielectric discharge electrodes maintaining contact with the food items for about 1 second to about 4 seconds.

26. The method of claim 23, wherein delivering a current to the plurality of dielectric discharge electrodes is performed continuously.

27. The method of claim 23, wherein delivering a current to the plurality of dielectric discharge electrodes is performed intermittently.

28-48. (canceled)
